(19) United States
(12) Patent Application Publication
(10) Pub. No.: US 2007/0240742 A1
(43) Pub. Date: Oct. 18, 2007

(54) ELECTROSTATIC PRECIPITATOR WASH SYSTEM

(76) Inventors: Kui-Chiu Kwok, Gurnee, IL (US); Russell Robison, Yamhill, OR (US)

Correspondence Address: TAYLOR & AUST, P.C.;ILLINOIS TOOL WORKS INC., 142 S. MAIN ST, PO BOX 560, AVILLA, IN, 46710, US

(21) Appl. No.: 11/766,829

(22) Filed: Jun. 22, 2007

Related U.S. Application Data
(63) Continuation-in-part of application No. 11/005,985, filed on Dec. 7, 2004.
Application No. 11/005,985 is a continuation-in-part of application No. 10/837,362, filed on May 1, 2004.
(60) Provisional application No. 60/815,943, filed on Jun. 23, 2006.

(51) Int. Cl. B03C 3/74; B08B 3/04

(52) U.S. Cl. 134/42; 96/43

(57) ABSTRACT

An electrostatic precipitator wash system includes a plurality of fluidic oscillator nozzles through which wash solution is directed at the electrostatic cell of the electrostatic precipitator. The nozzles are provided in a manifold rotatable about an axis of the manifold. The manifold is rotated through an arc of about 90° while emitting wash solution toward the cell in an oscillating stream of drops.

### CROSS-REFERENCE TO RELATED APPLICATIONS

The present regular U.S. Patent Application claims the benefits of U.S. Provisional Application Ser. No. 60/815,943, filed on Jun. 23, 2006; and is a continuation-in-part of U.S. patent application Ser. No. 11/005,985 filed on Dec. 7, 2004; which is a continuation-in-part of U.S. application Ser. No. 10/837,362, filed on May 1, 2004.

### FIELD OF THE INVENTION

The present invention relates generally to electrostatic precipitators, and, more specifically, to wash systems used to clean electrostatic precipitators used for cleaning exhaust air, such as from kitchens.

### BACKGROUND OF THE INVENTION

It is known to use electrostatic precipitators to remove particles from air streams before the air is discharged into the atmosphere. For example, electrostatic precipitators are used to clean kitchen exhaust air of grease and other cooking residue and byproducts. It is known to use different screens, filters and other air cleaning devices ahead of the electrostatic precipitator. An electrostatic precipitator can remove small particles that are not captured efficiently by such other devices, and may therefore be the terminal cleaning device before the air is discharged. Grease, smoke, odor and other contaminants can be removed with electrostatic precipitators. A known electrostatic precipitator product line for kitchen exhaust is available from Gaylord Industries, Tualatin, Oregon and is marketed under the product line known by the trademark “Clear Air”™ Pollution Control Unit “ESP” Series Electrostatic Precipitators. The “Clear Air”™ Pollution Control Unit has achieved acceptance in the market.

The basic operation of an electrostatic precipitator is known. An electrostatic cell includes conductive plates, often made of aluminum, that are closely spaced. For example, one-quarter inch spacing is used in the aforementioned electrostatic precipitator from Gaylord Industries. In the electrostatic cell, alternate plates are energized such as, for example, with 5,000 volts of DC power, and the plates between the energized plates are grounded. At an entry location to the cell, a series of thin wires are spaced from on another by a distance of approximately four inches. The wires, referred to as ionizing wires, are energized with 10,000 volts DC. As an air stream carrying contaminant particles enters the cell, the particles pass over the ionizing wires and receive a positive charge. As the charged particles continue through the cell, the positive plates repel the charged particles, and the negative or grounded plates attract the charged particles. As a result, smoke, grease and other contaminants are collected on the grounded plates.

Since the contaminant particles are attracted to and accumulate on the plates, the plates become covered with a coating of the contaminant particles.

For continued efficient operation, it is necessary that the plates be cleaned periodically. In some installations the plates are removed for cleaning, which can clean the plates adequately, but also can be inefficient and labor intensive.

It is known to position spray nozzles on opposite sides of an electrostatic cell and supply the nozzles with a cleaning solution, to clean the cell in place automatically. In known, automatic cleaning systems, a large volume of hot water and detergent is required to complete each cleaning. In commercial kitchens, it is known to operate an automatic cleaning system each day. For an in-place cleaning system on an electrostatic cell measuring about two feet by two feet, as much as 350 gallons of hot water is required for each cleaning. The cost for detergent and energy to heat the water is a significant expense for the business. Heating the contaminant layer by using hot water for cleaning facilitates releasing the particles from the surfaces of the cell. In known systems, for improved cleaning, the water is heated to temperatures higher than standard water heater temperatures, thereby requiring booster heaters at additional operating expense. Known cleaning systems use relatively fine spray mists, and thermal loss from each mist droplet is significant before the mist droplet reaches the surface to be cleaned and transfers the heat energy remaining therein to the coating of contaminants on the surface.

### SUMMARY OF THE INVENTION

The present invention uses improved spray distribution of optimally sized droplets that hit with greater impact and provide more effective heat transfer to the contaminants on the surface being cleaned. The present invention provides more efficient transfer of both kinetic and thermal energy to the surface being cleaned.

In one aspect of one embodiment of the present invention a wash system for an electrostatic precipitator cell is provided with a manifold in spaced relationship to the cell and a plurality of fluidic oscillator nozzles disposed in the manifold and directed toward the cell. A wash solution supply source is provided in fluid communication with the manifold.

In another aspect of another embodiment of the present invention an electrostatic precipitator is provided with an electrostatic cell and first and second manifolds disposed in spaced relationship to the cell. A plurality of fluidic oscillator nozzles are disposed in each of the first and second manifolds, the fluidic oscillator nozzles being directed toward the cell for emitting oscillating streams of fluid against the cell.

In a further aspect of a further embodiment of the present invention a method for cleaning in place an electrostatic cell of an electrostatic precipitator includes steps of supplying a heated and pressurized wash solution to a plurality of nozzles; emitting the fluid from the nozzles in an oscillating stream of drops;

and moving the nozzles relative to the electrostatic cell while emitting the oscillating stream of drops.

An advantage of the present invention in one form is providing efficient operation of an automated cleaning system for an electrostatic precipitator.

Another advantage of the present invention in another form is providing improved transfer of kinetic and thermal energy from a liquid spray cleaning system to the contaminate layer to be removed from a surface.

Still another advantage of the present invention in still another form is providing an automated cleaning system for an electrostatic precipitator that cleans the precipitator efficiently, with reduced water consumption and lower water temperatures and pressures.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of an electrostatic precipitator wash system in accordance with the present invention;

FIG. 2 is an enlarged fragmentary view of one portion of the wash system;

FIG. 3 is an end view of the wash system shown in FIG. 1;

FIG. 4 is an end view of an opposite end of the wash system;

FIG. 5 is a schematic illustration of a wash pattern from nozzles in a manifold of a wash system in accordance with the present invention;

FIGS. 6-11 illustrate one embodiment of a fluidic oscillator nozzle for use in the present invention;

FIG. 12 is a schematic illustration of the wash pattern from one nozzle in a wash system of the present invention;

FIGS. 13-17 illustrate another embodiment of a fluidic oscillator nozzle for use in the present invention;

FIG. 18 is a graphic of drop velocity vs. pressure;

FIG. 19 is a cable depicting characteristics of different drop sizes;

FIG. 20 is a graphic evaporation heat loss versus temperature for certain drop sizes; and

FIG. 21 is a graph comparing cleanliness and water consumption for a known mist washing system and a system of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

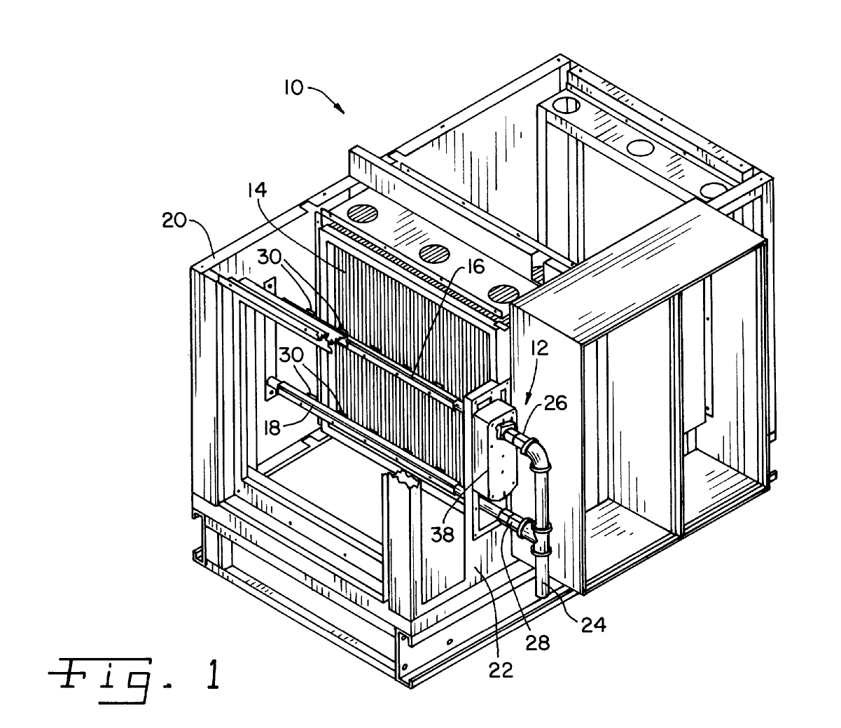

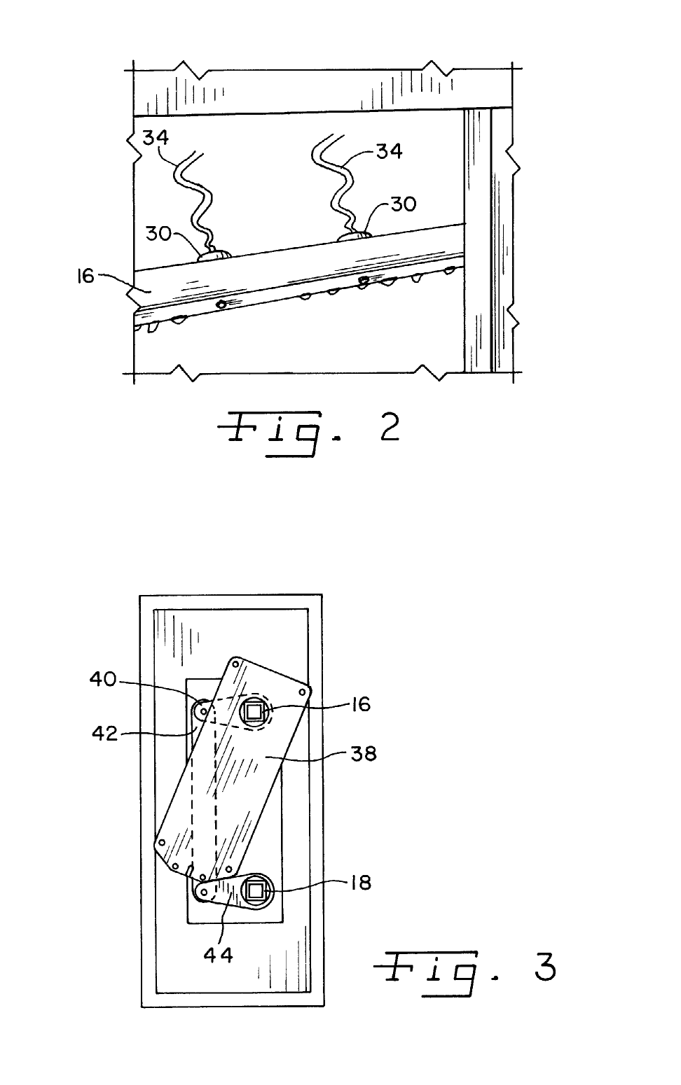

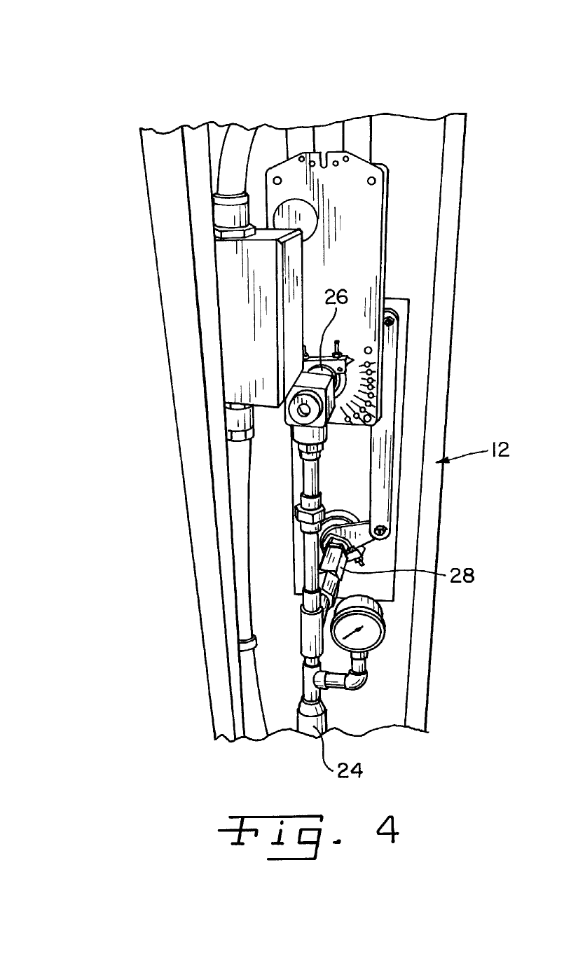

Referring now more specifically to the drawings and to FIG. 1 in particular, an electrostatic precipitator 10 having a wash system 12 in accordance with the present invention is shown. Precipitator 10 includes an electrostatic cell 14 through which a stream of exhaust air passes for cleaning, in known manner. The operation of electrostatic precipitator 10 to clean an air stream is known to those skilled in the art and will not be described in further detail herein. Wash system 12 is provided for cleaning cell 14 periodically, to remove accumulated contaminants from surfaces of cell 14. Wash system 12 can be used on different types of electrostatic precipitator cells, and the particular configuration shown for electrostatic precipitator 10 and cell 14 thereof are merely exemplary.

Wash system 12 includes manifolds 16 and 18 positioned on one side of cell 14, and extending across the face of the cell between side walls 20, 22 at opposite ends. A wash solution supply line 24 provides a pressurized solution of hot water and detergent to manifolds 16 and 18 via rotatable link connections 26, 28 respectively. Manifolds 16 and 18 each include a plurality of fluidic oscillator nozzles 30 directed at electrostatic cell 14, to discharge wash solution from the manifolds toward and against the surfaces of electrostatic cell 14.

The exemplary manifolds 16 and 18 shown in the drawings include five nozzles 30 each, but the number can vary depending on the size of cell 14 being cleaned. Further, while two manifolds 16, 18 are shown in the exemplary embodiment, it should be understood that a single manifold or more than two manifolds also can be used, depending on the size and shape of cell being cleaned. For an electrostatic precipitator cell measuring 2 feet by 2 feet, two manifolds 16, 18 have been used successfully, each manifold having five nozzles 30.

The term “fluidic oscillator nozzle” is intended to mean generally any nozzle that outputs an oscillating stream of fluid. U.S. patent application Ser. No. 10/837,632 entitled “Ware Washer Machine With Fluidic Oscillator Nozzles”, published as U.S. Patent Application Publication 2004/0250937; and U.S. patent application Ser. No. 11/005,985 entitled “Warewash Machine Arm and Nozzle Construction With Set Spray Pattern,” published as U.S. Patent Application Publication US 2005/0077399, are each incorporated by reference herein in their entirety and disclose fluidic oscillator nozzles suitable for use in electrostatic precipitator wash systems in accordance with the present invention. However, other types of fluidic oscillator nozzles also can be used.

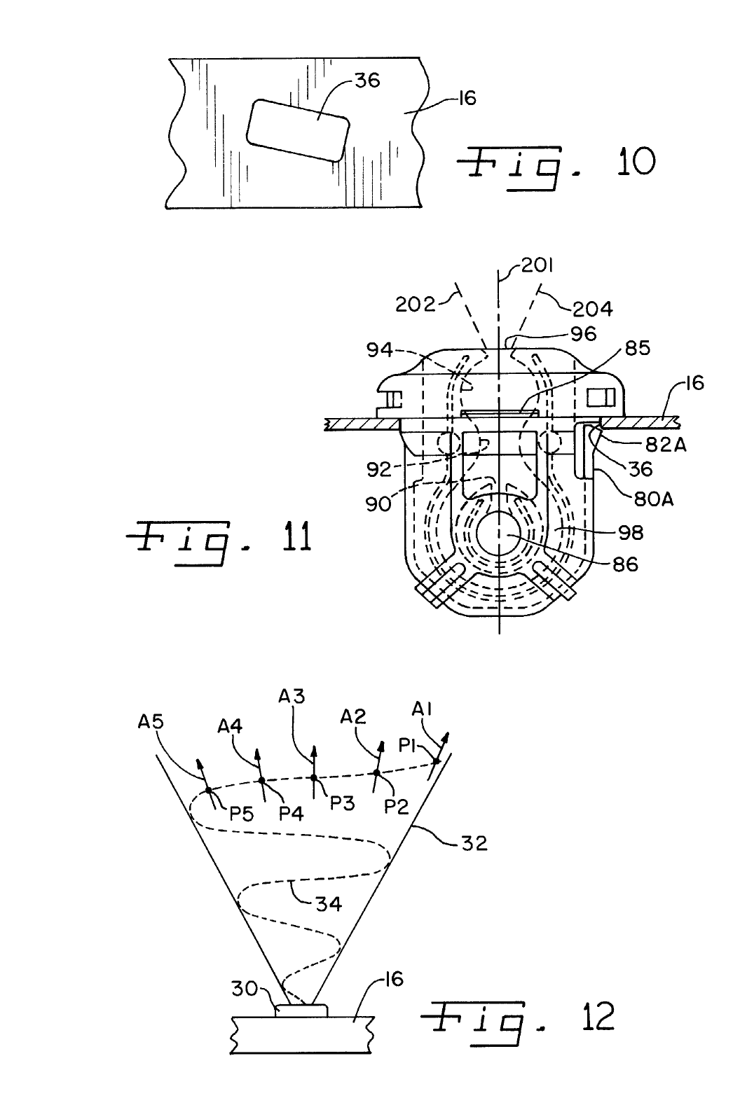

In a fluidic oscillator nozzle, the direction of the output stream of fluid varies in an oscillatory manner as will be described in greater detail below. In the case of liquids such as a wash liquid for the electrostatic precipitator wash system of the present invention, the stream of liquid is made up of a series of drops of the wash liquid. A fan-shape spray pattern 32 results, defined by the sweep of the output stream 34 of each nozzle 30 as shown in FIG. 5, with the output stream 34 at a given moment in time for one nozzle 30 being shown in FIG. 11. Arrows A1-A5 reflect the instantaneous direction of different drops (P1-P5) of the stream output by the port at different times, A1 representing instantaneous direction for drop P1 of the stream output at an earliest point in time, A2 representing instantaneous direction for drop P2 output at a later time, and so on. Angles of individual nozzles 30 relative to others of the nozzles 30 and to the surface of electrostatic cell 14 can be selected so that the output oscillating streams of adjacent nozzles 30 do not interfere with one another, yet provide complete coverage for thorough cleaning of electrostatic cell 14. FIG. 10 illustrates that an opening 36 for receiving nozzle 30 in fluid flow relationship in manifold 16 or 18 can be at an angle to an axis of the manifold. Different openings 36 for different nozzles 30 can be at different angles to the longitudinal axis of the manifold.

Nozzles 30 are provided on manifolds 16, 18 that also oscillate on the manifold axis. A motor/controller 38 (FIG. 3) is operatively connected to manifolds 16 and 18 for rotating each manifold about the manifold axis, to thereby tilt nozzles 30 in substantially upward and downward cyclical reciprocating paths relative to the confronting face of cell 14. Motor controller 38 is drivingly connected to manifolds 16 and a via an arm 40 to a link 42 and an arm 44 connected to manifold 18. Accordingly, motor/controller 38 drives both manifold 16 and manifold 18 via the interconnection of link 40 with arms 42 and 44. Accordingly, wash solution is emitted from each nozzle 30 in a variable stream orientation, as described previously herein; and also is provided over a substantial vertical extent of cell 14 as manifolds 16 and 18 are rotated through an arc of about 90 degrees about the axis of each, and the spray pattern 34 from each nozzle 30 is moved upwardly and downwardly relative to the surface of cell 14. It should be understood that manifolds 16, 18 can be moved also in ways other than rotational about their axes as described in the exemplary embodiment. For example, linear up and down movement, lateral movement or angular movement also can be used. Any type of relative movement between the nozzles and the cell can be used to increase the coverage areas of individual nozzles.

In contrast to fanjet nozzles that output water in a spread pattern but with drops simultaneously output in multiple directions within the spread, a fluidic oscillator nozzle outputs a stream of drops with changing instantaneous directions. Fluidic oscillator nozzles can provide an advantage of larger output drop size (in the case of liquids) for a given flow rate than known fanjet nozzles having the same flow rate, providing better washing or rinsing and also reducing heat loss to the air. In one example, fluidic oscillator nozzles output an average drop size at least twenty-five percent greater than that output by a typical fanjet nozzle having the same flow rate. It is contemplated that in some wash systems in accordance with the present invention, nozzles 30 can be supplied with a relatively constant pressure wash fluid, but will produce a pulsing output, by using a manifold having an associated variable pressure mechanism to vary the pressure within the liquid manifold in a pulsed manner.

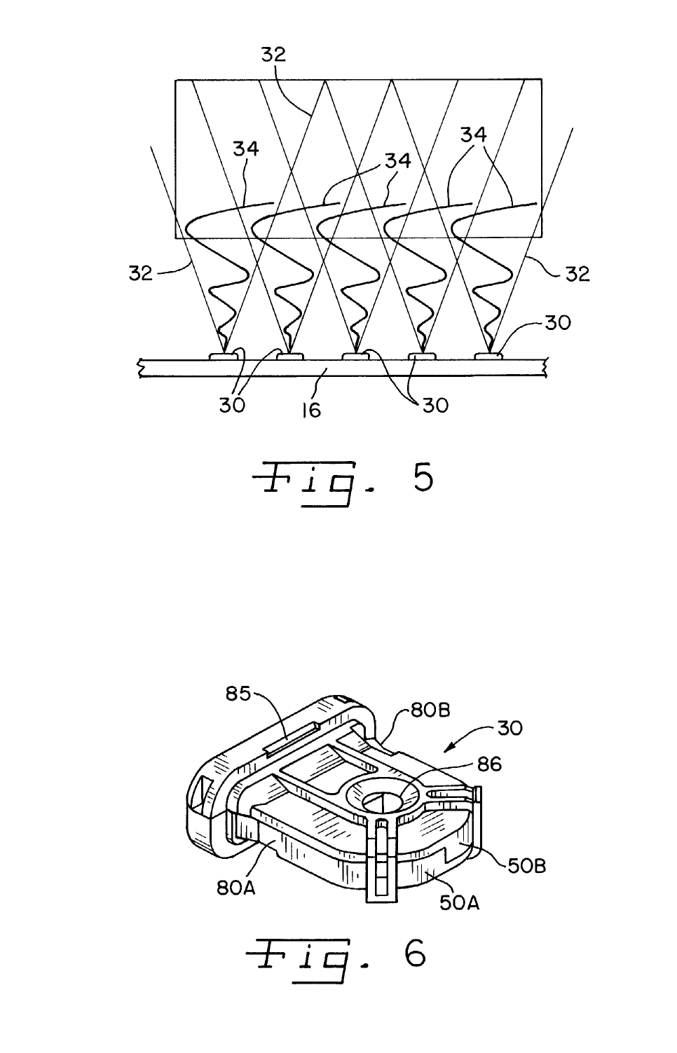

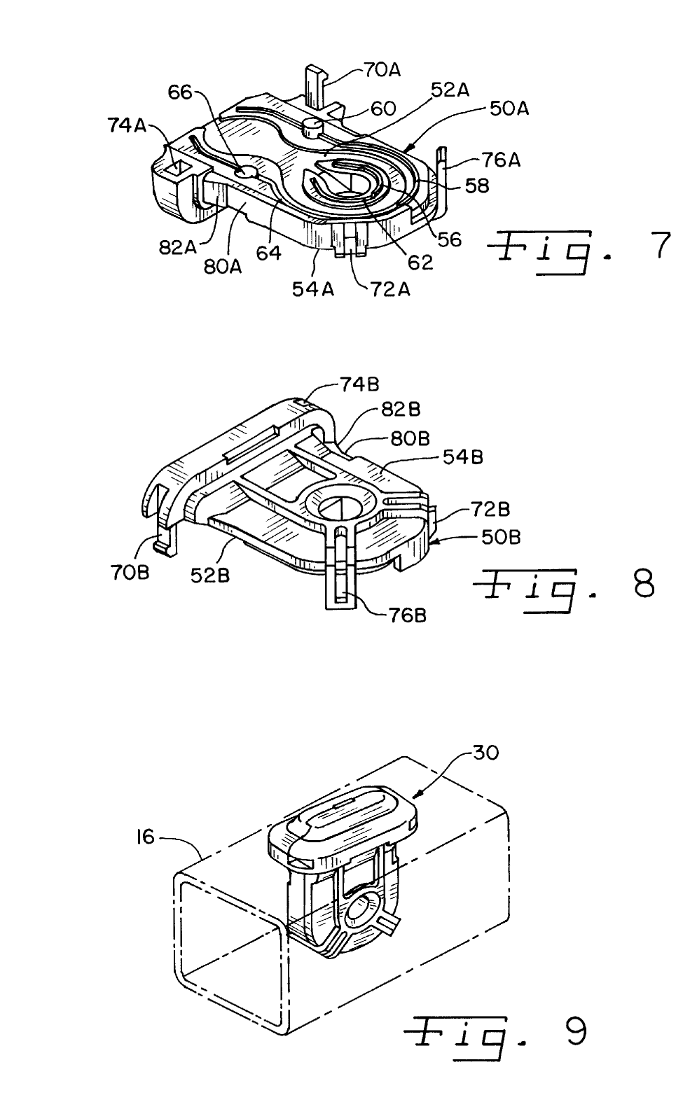

One embodiment of a fluidic oscillator nozzle 30 is shown in FIGS. 6-11. Nozzle 30 includes a first nozzle side part 50A, a second nozzle side part 50B constructed separate from the first nozzle side part 50A and connected to the first nozzle side part to form a functioning, complete fluidic oscillator nozzle 30, wherein the first nozzle side part 50A and second nozzle side part 50B are identical in shape and configuration. Each nozzle side part may be of unitary, molded plastic construction, with a Polyvinylidene Fluoride (PVDF) homopolymer representing one acceptable material. It is also recognized that other plastics can be used, or the nozzle can be constructed of other materials including, by way of example, metallic materials or ceramics. Further, rather than being molded, other construction techniques for the nozzle side parts could be used including, by way of example, machining, etching, forming and EDM.

Nozzle side parts 50A and 50B have respective internal sides 52A and 52B, and respective external sides 54A and 54B. The internal sides have identical protrusions (e.g., curved ridge 56, curved ridge 58 and post 60) and identical recesses (e.g., curved recess 62, curved recess 64 and post receiving aperture 66). In final construction, the first nozzle side part 50A is arranged in orientation relative to and adjacent the second nozzle side part 50B, such that the protrusions of the first nozzle side part 50A frictionally engage into the recesses of the second nozzle side part 50B, and the protrusions of the second nozzle side part 50B frictionally engage into the recesses of the first nozzle side part 50A. Such engagement aids in holding the side parts together and also performs a sealing function for the cavity formed internal of the nozzle 30.

Both the first nozzle side part 50A and the second nozzle side part 50B include at least one exterior mating finger (e.g., flexible fingers 70A, 70B and rigid fingers 72A, 72B) and at least one exterior mating opening (e.g., fixed openings 74A, 74B and movable openings 76A, 76B). In final construction the first nozzle side part 50A is arranged in orientation relative to and adjacent the second nozzle side part 50B such that the exterior mating finger(s) of the first nozzle side part 50A engage the exterior mating opening(s) of the second nozzle side part 50B and the exterior mating finger(s) of the second nozzle side part 50B engage the exterior mating opening(s) of the first nozzle side part 50A.

The nozzle may also include at least two flexible fingers 80A and 80B to facilitate snap-fit insertion of the nozzle into an appropriately sized and shaped opening 36 of the manifold, such fingers including respective surfaces 82A, 82B ramped to engage an opening during insertion to flex the fingers to an insertion position (e.g., inward toward the nozzle body), and the fingers returning to a holding position (FIG. 11) after insertion. The protruding part of the nozzle 30 includes a notch 85 to receive a tool (such as a screwdriver) to enable removal of the nozzle from the opening as by a prying operation. In one example, the protruding part of the nozzle may protrude no more than about 0.4 inches in order to reduce the potential for nozzle breakage, but variations on this distance are possible. For example, the nozzles can protrude by a greater or lesser distance or can be flush with or below the mounting surface so long as the spray pattern is not interfered with. In alternative embodiments, the nozzle may include exterior threads to facilitated engagement with the opening 36. In the case of metal nozzles, the nozzles could be welded or otherwise joined to the manifold. The use of fasteners is also contemplated.

While the foregoing nozzle description primarily contemplates a nozzle in which the identical side parts are snap-fit together, it is recognized that other connection techniques could be used. For example, connection by one of an adhesive, one or more fasteners, a welding operation, such as ultrasonic welding for plastics, or a brazing operation (for metals) might be used. Further, while the foregoing nozzle description primarily contemplates first and second nozzle side parts constructed separately, the parts could be constructed together. By way of example, a clamshell-type configuration including a connecting hinge could be provided between a single molded plastic piece including the two side parts, enabling the side parts to be folded against each other and connected together, as by any suitable technique previously mentioned, to form the internal cavity of the nozzle. Still further, a one piece nozzle construction could also be used. For example, an investment cast one-piece nozzle could be used.

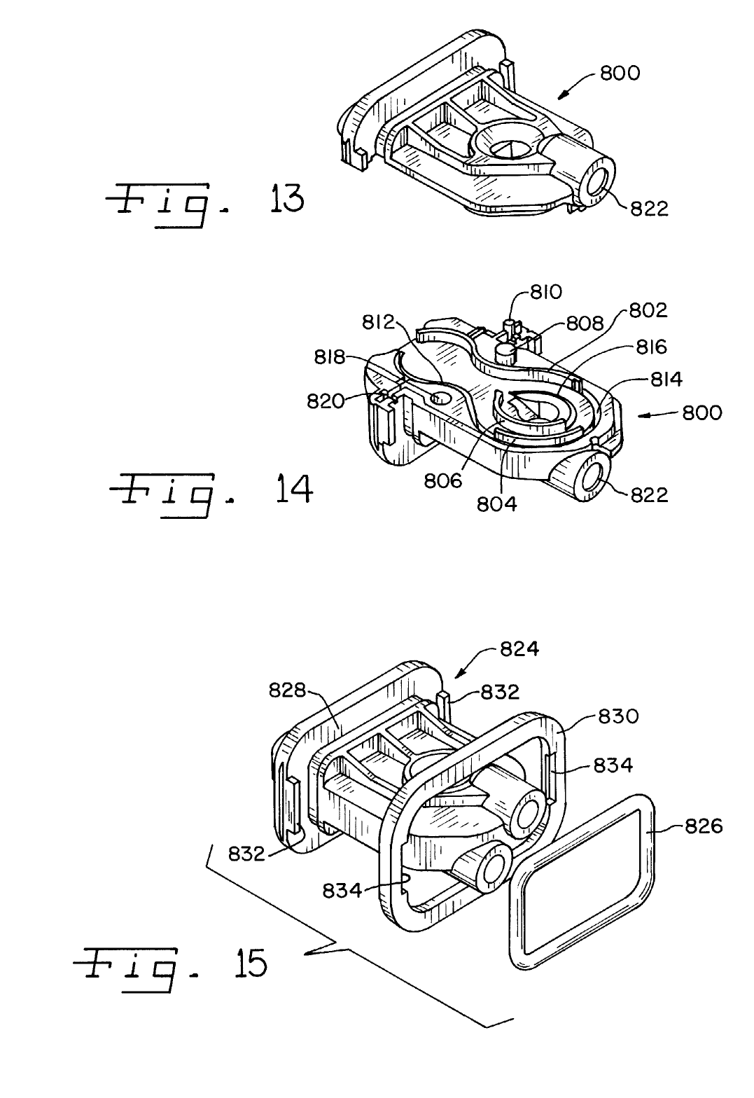

Referring again to FIG. 11, a description of the internal cavity of the illustrated nozzle is provided. The nozzle includes openings 86 on opposite sides (e.g., each side part is formed with an opening that will define the internal cavity when the side parts are connected). In particular, the openings lead to an orifice 90. The size of the orifice 90 in combination with the pressure of the fluid delivered thereto controls the flow rate of nozzle 30. The fluid stream exiting the orifice 90 is directed towards a throat 92 that opens to a body portion 94 having an associated exit port 96 through which the fluid stream is output from nozzle 30. A feedback loop 98 located adjacent the orifice 90 provides a changing pressure differential to vary the direction of the output fluid stream in an oscillating manner. In particular, the fluid stream output from the orifice 90 tends to attach to one sidewall of the throat 92, and as a result of the “Coanda Effect,” follows that wall through body portion 94. When the fluid stream attaches to one sidewall it tends to create a low pressure condition on the same side of the feedback loop 98, due to the high speed flow near that side of the feedback loop 98. As a result, fluid is drawn around the feedback loop toward the low pressure region and toggles the fluid stream exiting the orifice 90 toward the opposite sidewall of the throat 92. These conditions repeat, and the fluid stream exiting the orifice 90 repeatedly moves back and forth attaching to the two opposed sidewalls, and thus oscillating in direction when output from the port 96 as seen in FIGS. 5 and 12. The angular orientation or instantaneous direction of the output stream with respect to an axis 201 of the nozzle varies over time. In particular, in the illustrated embodiment the output stream oscillates back and forth relative to a plane, where the illustrated nozzle axis 201 lies in the plane. The two extremes of oscillation are represented at dashed lines 202 and 204. For ease of reference the illustrated nozzle axis 201 is defined by a line passing though the center point of the nozzle port 96 and the center point of the orifice 90. However, the angular orientation or instantaneous direction of the output stream can be said to vary relative to any nozzle axis defined by a line passing through any two spaced apart points on the nozzle, where the relative position between the two spaced apart points does not change.

Varying degrees of oscillation can be achieved by modifying the nozzle configuration. Oscillating frequency is also affected by fluid pressure and medium (e.g., gas or liquid). Further, the shape and orientation of the feedback loop provided within the nozzle could vary significantly to alter performance.

It is recognized that the foregoing nozzle construction is one of many possible fluidic oscillator nozzle constructions that could be used. Further, while the typical fluidic oscillator nozzle construction provides an output stream that, more or less, moves back and forth in two-dimensions along a plane, it is contemplated that other fluidic oscillator nozzle constructions could be used where the oscillation occurs in three dimensions. Further, it is also recognized that nozzle constructions in which the output stream technically does not “oscillate” are possible, such as an output stream that moves in one direction to produce a helical or cylindrical output, an expanding helical or cone-shaped output or an output stream having an orientation that varies randomly/chaotically relative to the axis of the nozzle. As used herein the terminology “variable stream orientation nozzle” is intended to encompass any and all such nozzle constructions, including fluidic oscillator nozzles, that output a stream of fluid with an instantaneous direction that varies over time relative to a nozzle axis, regardless of whether the variance is regular, random, oscillating or non- oscillating.

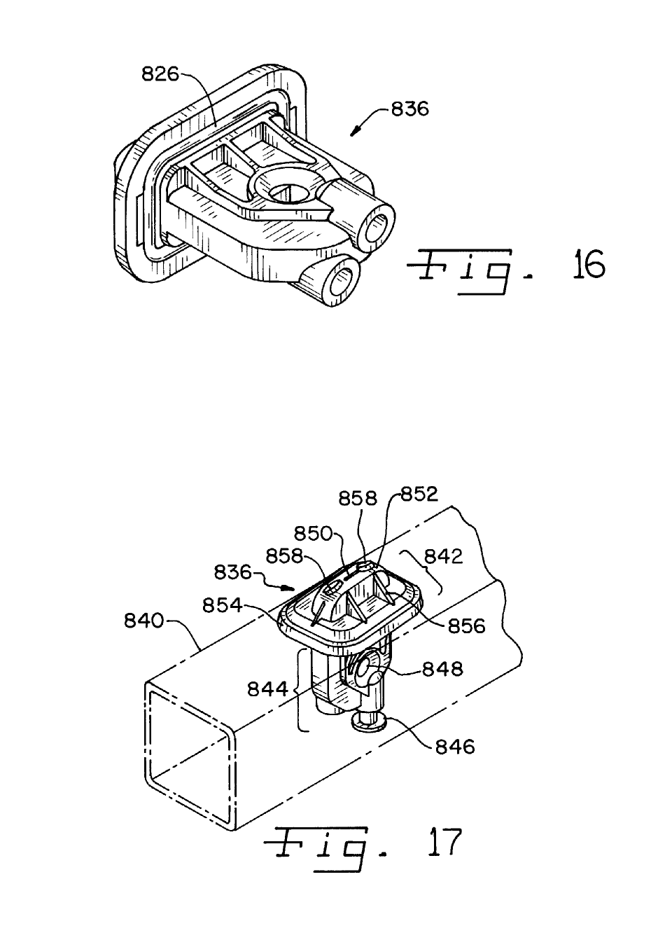

Referring now to FIGS. 13-17, an alternative embodiment of a fluidic oscillator nozzle and its installation in a manifold are shown. FIGS. 13 and 14 represent identical nozzle halves 800 oriented on the page in a manner that permits them to be fitted together to form a functional nozzle. The internal side of each nozzle half 800 includes protrusions (e.g., curved protrusions 802, 804 and 806, and posts 808 and 810) that mate with corresponding recesses (e.g., curved recesses 812, 814 and 816 and cylindrical openings 818 and 820) on the other nozzle half in a friction fit manner, to aid in holding the two nozzle halves together in assembled form. An ultrasonic welding process, solvent welding process or heat and pressure welding process may also be used to connect the nozzle halves together more permanently. Screws or other fasteners could also be used in addition to or in place of the welding and/or friction fit. Each nozzle half 800 also includes a boss 822, which can be used for connecting the nozzle in a manifold as described in further detail below. Notably, the orifice, throat, body portion, output port and feedback loop of the nozzle created by combined nozzle halves 800 are all primarily defined by the curved protrusions 802, 804 and 806.

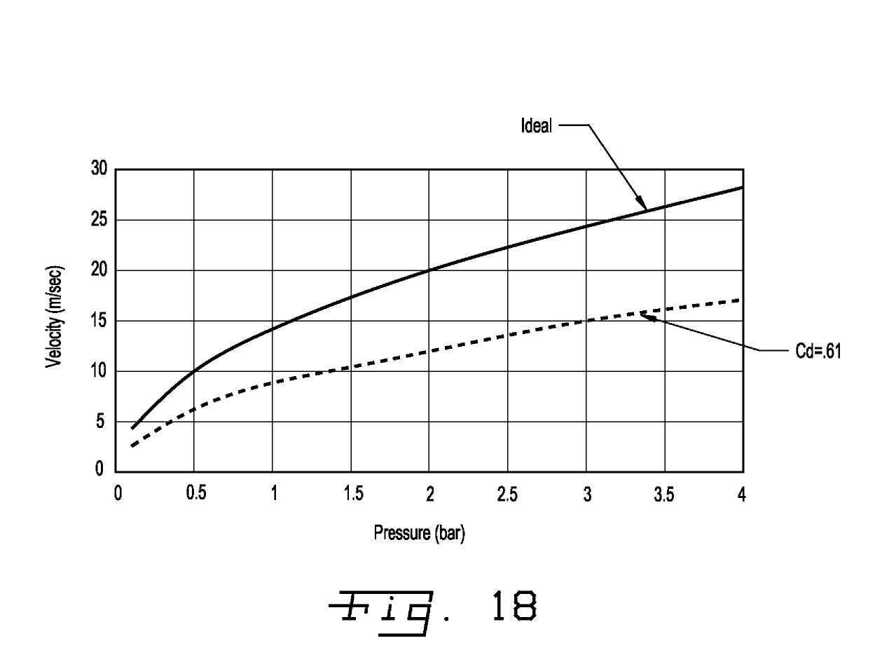

As shown in FIG. 15, nozzle halves 800 combine to form a functional nozzle 824. A gasket/seal 826 may be provided for location against surface 828 of the nozzle, with gasket housing 830 provided to limit the outward movement of the gasket 826. Protrusions 832 of the nozzle 824 are sized for frictionally fitting in recesses 834 of the gasket housing 830 to hold the components together in the nozzle assembly form 836 shown in FIG. 16.

Nozzle assembly 836 is shown mounted in an exemplary manifold 840 in FIG. 17, with portion 842 of the assembly protruding from manifold 840 and with portion 844 internal to manifold 840. A screw 846 is positioned through an opening in the bottom of the manifold and threaded into boss 822 to secure the nozzle assembly 836, with the screw tightened sufficiently to cause the gasket 826 to form a seal against the top of the manifold 840. Fluid under pressure within the manifold 840 flows into inlet opening 848 of the nozzle and is ejected from exit port or orifice 850 in an oscillating manner as previously described. Notably, exit port 850 is located near the top of an upwardly projecting nozzle head 852 of the nozzle assembly, where nozzle head 852 is surrounded by a mounting flange 854 having an underside adjacent the top surface of manifold 840. Ribs 856, which may be molded with the nozzle, are disposed at multiple locations around the nozzle head 852 and provide increased stiffness to aid in keeping the nozzle head from breaking or bending if impacted. The ribs also can aid in keeping the nozzle part flat during molding and when the nozzle halves 800 are welded together. Nozzle port guards 858, illustrated in the form of projecting bumps, are disposed on opposite sides of the nozzle port 850. The port guards 858 project above the nozzle port 850 so that the port guards 858 are in position to be impacted before the nozzle port 850. In the event the manifold 840 is removed from an electrostatic precipitator wash system for cleaning, it is possible that the manifold 840 could be subjected to impacts, such as an operator banging the manifold against a sink or other structure. In such cases nozzle guards 858 should take the brunt of any impact instead of the nozzle port 850, thereby preventing or limiting damage/deformation of the nozzle port 850, which could adversely affect the spray pattern of the nozzle.

Drop size management of wash fluid for an electrostatic precipitator wash system of the present invention can be achieved in accordance with the teachings from International Patent Application Number PCT/US2005/044011 entitled “Warewash Machine Having Controlled Drop Size And/Or Weber Number And Related Design Process,” which was published on Jun. 15, 2006, as International Publication Number WO 2006/06297 A1, the disclosure of which is incorporated by reference herein in its entirety. Research efforts have indicated that in an electrostatic precipitator wash system direct management of wash fluid drop size can yield efficient systems capable of cleaning electrostatic cells effectively.

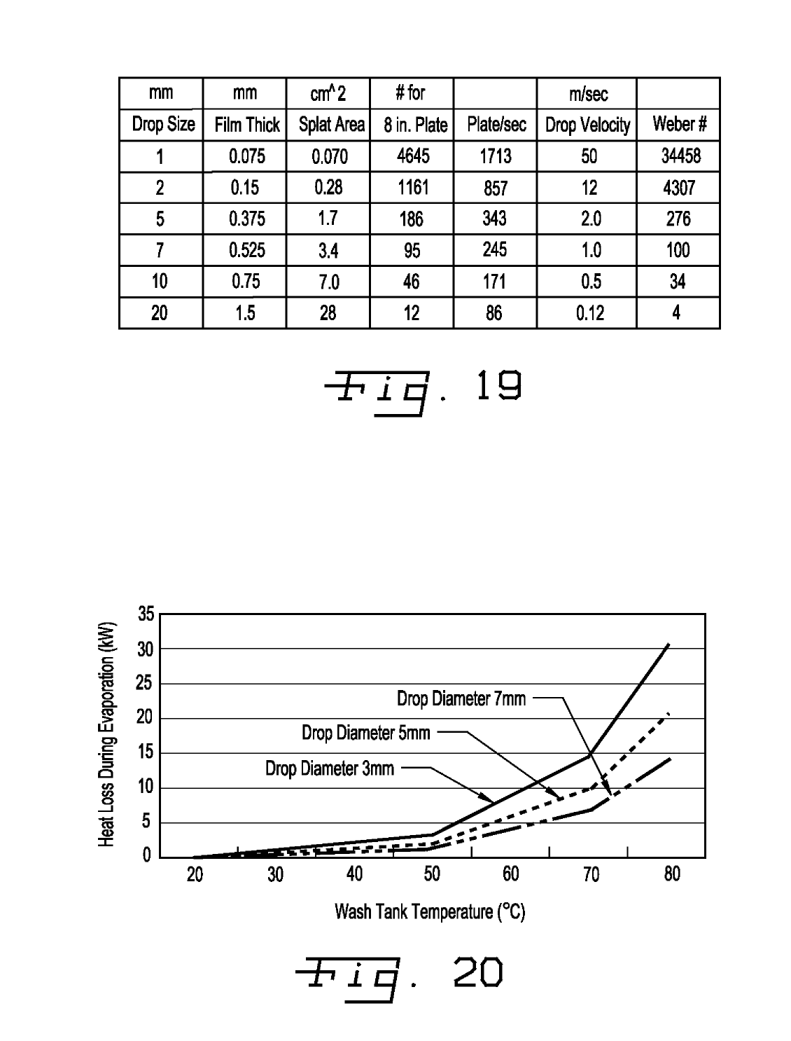

Optimally sizing drops of cleaning solution improves the efficiency of heat transfer to the surface being cleaned. The size generally depends on the velocity of the drop, which in turn depends on pressure at the orifice from which the stream forming the drop emerges. FIG. 18 shows the general relationship between drop velocity and driving pressure for practical nozzle sizes.

When drops at low velocities and low Weber numbers (the Weber number is, for a drop, the ratio of the inertial energy to the surface tension energy), impact a surface they expand into disk shaped areas. Weber number (We) can be expressed as:
We−(ρv²1)/σ
Where:
1=characteristic length
v=velocity
σ=surface tension
ρ=density

The final diameter of the wetted area is dependent on surface tension. In the extreme case of the high surface tension, a small drop will immediately contract into a hemispherical dome and not expand across the surface, but instead will bounce from the surface. In the practical wash case, the final disk size is typically 2.5 to 4 times the original drop diameter. The rate at which the impacting drop expands into a disk shape depends on the impact velocity. If the impact velocity is low enough, the expanding disk can keep ahead of the impacting drop. If the velocity is high, then water in the impacting drop will splatter or bounce, and not maintain contact with the surface, which is preferred if heat in the drop is to be transferred to the surface efficiently. Typically, the transition between a high and low case is at Weber numbers around 1000, or more generally in the range of about 800 to 1200.

Drops of hot water transfer heat to a surface by: a) forced convection as the drop moves across the surface and b) conduction as the thin expanded layer transfers heat to the surface. The expanding water disk from the drop impacting the surface transfers heat as the water flows over the surface while the disk expands while maintaining contact with the surface. A fully-expanded drop transfers heat by conduction because there is no movement. Drop size unto itself is important. For Weber numbers less than 1000 (typically drop sizes less than 5 mm and velocities less than 4 m/sec) the film thickness of expanded drops on surfaces for larger drops is more than it is for small drops, since the drop expansion ratio is independent of drop size. This means that conduction heat transfer is less effective for larger drops. The time needed to transfer the heat energy of the drop becomes much longer than the residence time of the drop on an inclined surfaces. The resultant effect can be envisioned by considering the extreme of a drop as large as the surface, not much of the water ever reaches very close to the surface as the very large drop impacts the surface and flows off. Experience shows that the threshold between large and small drops is in the range of 2 to 7 mm, or more typically 5 mm.

The table shows the number of “accurately and strategically” impinging drops required to cover a surface of an 8 inch circular plate. It also shows the number of times per second the plate will be covered, the drop velocity and Weber number. As reflected in FIG. 19, as the drop size decreases, in order to maintain the set flow rate the velocity of the drops output by the nozzles must be increased (as by increasing the pressure). As a result, the Weber number of the drops also increases and will eventually become too high. When the Weber number is too high, the surface tension energy is too low to hold the drop together in a desired, single volume. Drops may break up while passing through the air, and any drops that make it to the surface in one piece will break apart and rebound from the surface, rendering much of the drop ineffective to transfer heat to the surface. While the Weber number for the larger drops is low, at some point the drops become too large, as the drops will be too thick when spread on the surface to effectively transfer heat by conduction, and much of the water of the drop will leave the surface before the desired amount of heat transfer has taken place. As a general rule, and again referencing the table of FIG. 19, if drop diameter is 2 mm or less drop velocity and Weber number are too large for the drops to be effective. If drop diameter is above 7 mm, film thickness becomes excessively high and the number of times a surface is impacted by drops becomes too low for effective heat transfer from the water drops to the surface. The optimum drop size is about 5 mm.

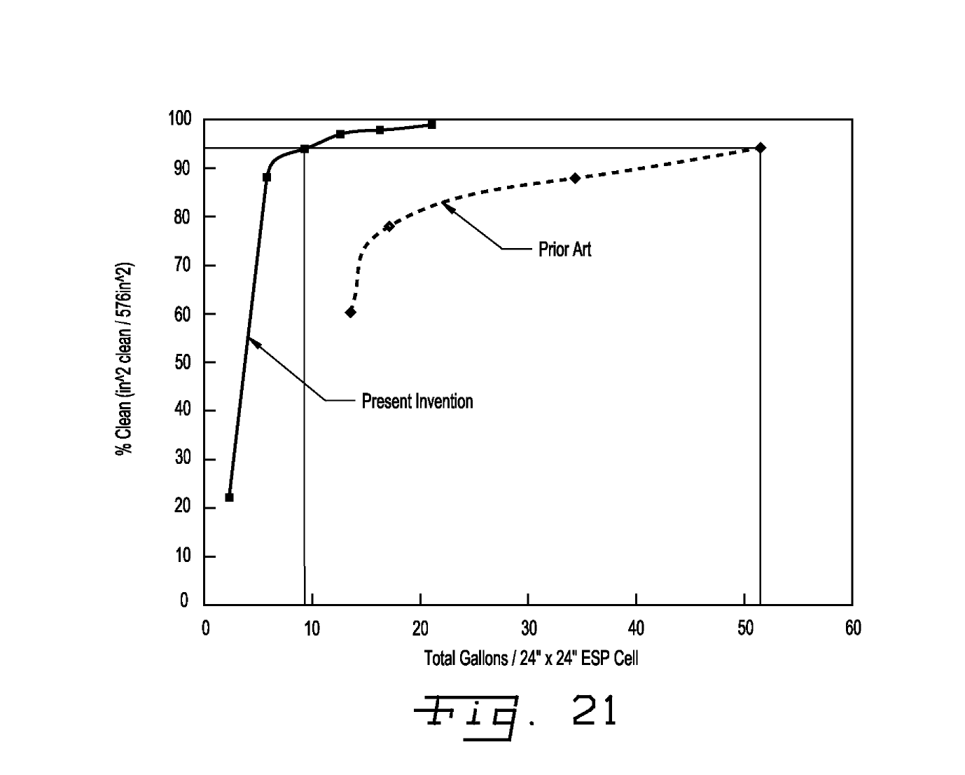

Hot water drops loose energy because of water evaporation from the drops. For a given flow rate, a flow made up of small drops has a significantly higher surface area than a flow made up of larger drops. The effective drop size on evaporated heat loss is shown in FIG. 20. To achieve the desired results, drop size distribution should be managed along with the mean drop size. Conventional fan nozzles produce broad drop size distributions; having both very large and very small drops in the same flow. Conventional conical spray nozzles can produce relatively uniform particle sizes, but very small particles in a spray mist. Fluidic oscillator nozzles can produce a fan shaped flow, at least on average, with more uniform drop sizes than from fan nozzles. Fluidic oscillator nozzles can be sized to output fluid streams that result in drop sizes, the majority of which are within a fairly narrow and larger drop size range.

Drop size management to promote efficient heat transfer from the hot wash solution drops to the electrostatic cell surface and the contaminants thereon also enhances the transfer of kinetic energy from the drops to the contaminants to promote physically dislodging the contaminants from the surface. Providing the drops of more consistent and predominantly larger sizes yet in a manner to reduce drop disintegration or rebound from the surface promotes efficient kinetic energy transfer. Accordingly, the present invention promotes efficient heat transfer and kinetic energy transfer to enhance cleaning the surface even with wash solution of lower temperature and pressure then in known mist cleaning systems.

Comparative data has been assembled for an electrostatic precipitator wash system of the present invention and a prior art mist washing system. In the known mist system used previously, a booster heater is required to raise the temperature of the wash water from that provided in typical hot water heaters to between about 160° F. and 180° F. A boost pump also is required to increase the water pressure to between about 60 PSI and 80 PSI. Cone spray nozzles are used on a stationary manifold. The system of the present invention used nozzles as described above on a manifold oscillating on its axis by about 90° to emit an oscillating stream of drops having dropped diameters in the range of about 2 mm to 7 mm and a substantially at about 5 mm diameter. Effective cleaning, comparable to that of the known system, is achieved using standard hot water heater temperature of about 140° F. and standard water system pressure of about 30 PSI. Less water is required, and cleaning occurs more quickly with the system of the present invention compared to the prior art system. Accordingly, the present invention can be used with standard hot water heater temperatures of up to about 140° F. without the need for boost heaters, and also can be used with standard supply pressures, typically not more than about 50 PSI, without the need for boost pumps.

FIG. 21 is a graph comparing water consumption and the degree of cleanliness achieved using a prior art mist washing system and a wash system of the present invention. As can be seen from the graph, a higher degree of cleanliness is achieved more quickly, using substantially less water than with the prior art system. Additional savings are realized in that, as described previously, the system of the present invention can use cooler water at a lower pressure than the prior art mist system that requires both a boost heater and a boost pump. As seen in the graph of FIG. 21, at a cleanliness level of 94%, the system of the present invention consumed only about 18% as much water as was consumed in the known mist cleaning system to achieve the same 94% cleanliness level. On a 24″×24″ electrostatic cell the present invention achieves a 94% cleanliness level with less than 10 gallons of water consumed. The prior art mist system required over 50 gallons of water to achieve the same and 94% cleanliness level.

It has been observed that wash fluid drops from fluidic oscillator nozzles as a described previously herein penetrate more effectively through an electrostatic cell then does the mist from previously known systems. Accordingly, a wash system of the present invention having a manifold or manifolds provided on one side of the electrostatic cell effectively cleans through the thickness of the cell. With multiple manifolds all provided on the same side of the cell, plumbing for wash fluid is thereby more simple than for previously known systems wherein wash nozzles are disposed on both sides of the electrostatic cell.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A wash system for an electrostatic precipitator cell, comprising:
a manifold disposed in spaced relationship to the cell;
a plurality of variable stream orientation nozzles disposed in said manifold and directed toward the cell; and
a wash solution supply source in fluid communication with said manifold.

2. The wash system of claim 1, said manifold being reciprocatingly rotatable about an axis of said manifold.

3. The wash system of claim 1, including a second manifold disposed in spaced relation to the cell;
a second plurality of variable stream orientation nozzles disposed in said second manifold and directed toward the cell; and
said wash solution supply source being in fluid communication with said second manifold.

4. The wash system of claim 3, each said manifold being reciprocatingly rotatable through an arc of about 90°.

5. The wash system of claim 3 both of said manifolds being disposed on a same side of the cell.

6. The wash system of claim 5, both of said manifolds being reciprocatingly rotatable about axes thereof.

7. The wash system of claim 6, both of said manifolds being rotatable through arcs of about 90°.

8. The wash system of claim 1, said manifold being reciprocatingly rotatable about an axis thereof through an arc of about 90°.

9. The wash system of claim 1, at least some of said variable stream orientation nozzles being fluidic oscillator nozzles.

10. An electrostatic precipitator, comprising:
an electrostatic cell;
first and second manifolds disposed in spaced relationship to said cell;
a plurality of fluidic oscillator nozzles disposed in each of said first and second manifolds, said fluidic oscillator nozzles being directed toward said cell for emitting oscillating streams of fluid from said first and second manifolds against said cell; and
a wash solution supply source in fluid communication with said first and second manifolds.

11. The electrostatic precipitator of claim 10, said first and second manifolds being disposed on a same side of said cell.

12. The electrostatic precipitator of claim 10, said first and second manifolds being reciprocatingly rotatable about axes thereof.

13. The electrostatic precipitator of claim 12, said first and second manifolds each being rotatable through an arc of about 90°.

14. The electrostatic precipitator of claim 13, said first and second manifolds being disposed on a same side of said cell.

15. The electrostatic precipitator of claim 13, said first and second manifolds being connected to each other by a drive link and being driven from a single drive source.

16. A method for cleaning in place an electrostatic cell of an electrostatic precipitator, said method comprising steps of:
supplying a heated and pressurized wash solution to a plurality of nozzles;
emitting the heated and pressurized wash solution from the nozzles in a varying orientation stream of drops; and
moving the nozzles relative to the electrostatic cell while emitting the stream of drops.

17. The method of claim 16, including heating the wash solution to no more than about 140° F.

18. The method of claim 16, including pressurizing the wash solution to not more than about 50 PSI.

19. The method of claim 18, including heating the wash solution to not more than about 140° F.

20. The method of claim 16, including emitting the wash solution from a plurality of rows of nozzles.

21. The method of claim 16, including moving the nozzles reciprocatingly through an arc of about 90°.

22. The method of claim 16, including controlling the sizes of drops emitted so that a substantial portion of the drops have diameters within a range of about 2 mm to 7 mm.

23. The method of claim 16, including controlling the sizes of drops emitted so that a substantial portion of the drops have diameters of about 5 mm.

24. The method of claim 16, said step of emitting performed by emitting the stream of drops in differing directions in an oscillating pattern.
